(19) United States
(12) Patent Application Publication
(10) Pub. No.: US 2003/0177011 A1
(43) Pub. Date: Sep. 18, 2003

(54) Audio data interpolation apparatus and method, audio data-related information creation apparatus and method, audio data interpolation information transmission apparatus and method, program and recording medium thereof

(76) Inventors: Yasuyo Yasuda, Tokyo (JP); Tomoyuki Ohya, Kanagawa (JP); Sanae Hotani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/311,217

(22) PCT Filed: Mar. 6, 2002
(86) PCT No.: PCT/JP02/02066

(30) Foreign Application Priority Data
Mar. 6, 2001 (JP) 2001-62316

(51) Int. Cl. G10L 13/04

(52) U.S. Cl. 704/265; 704/501

(57) ABSTRACT

An interpolation device for judging a state of sounds of a frame at which an error or a loss has occurred in the audio data and carrying out the interpolation according to that state is constructed by an input unit for entering the audio data, a detection unit for detecting the error or the loss of each frame of the audio data, an estimation unit for estimating the interpolation information of the frame at which the error or the loss is detected, and an interpolation unit for interpolating the frame at which the error or the loss is detected, by using the interpolation information estimated for that frame by the estimation unit.

### TECHNICAL FIELD

The present invention relates to audio data interpolation device and method, audio data related information producing device and method, audio data interpolation information transmission device and method, and their programs and recording media.

### BACKGROUND ART

Conventionally, at a time of transmitting audio data in mobile communications, for example, the acoustic coding (AAC, AAC scalable) is carried out and its bit stream data are transmitted on a mobile communication network (line switching, packet switching, etc.).

The coding that accounts for the transmission error has been standardized by the ISO/IEC MPEG-4 Audio, but there is no specification for the audio interpolation technique for compensating the residual errors (see, ISO/IEC 14496-3, “Information technology Coding of audio-visual objects Part 3: Audio Amendment 1: Audio extensions”, 2000, for example).

Conventionally, the interpolation according to the error pattern has been carried out with respect to frame data at which an error has occurred in the case of the line switching network or a packet loss has occurred in the case of the packet switching network. As the interpolation method, there are methods such as the muting, the repetition, the noise substitution, and the prediction, for example.

FIGS. 1A, 1B and 1C are figures showing examples of the interpolation. The waveforms shown in FIGS. 1A, 1B and 1C are examples of the transient waveform, where the sound source is castanets. FIG. 1A shows the waveform in the case of no error. Here, suppose that an error has occurred at a portion enclosed by a dashed line in FIG. 1A. FIG. 1B is an example in which that portion is interpolated by the repetition, and FIG. 1C is an example in which that portion is interpolated by the noise substitution.

FIGS. 2A, 2B and 2C are figures showing other examples of the interpolation. The waveforms shown in FIGS. 2A, 2B and 2C are examples of the steady waveforms, where the sound source is a bagpipe. FIG. 2A shows the waveform in the case of no error. Here, suppose that an error has occurred at a portion enclosed by a dashed line in FIG. 2A. FIG. 2B is an example in which that portion is interpolated by the repetition, and FIG. 2C is an example in which that portion is interpolated by the noise substitution.

There are the interpolation methods as in the above, but which interpolation method is most suitable depends on the source source (sound characteristics) even for the same error pattern. This is based on the recognition that there is no interpolation method that suits all the sound sources. In particular, which interpolation method is most suitable depends on the instantaneous characteristics of the sound even for the same error pattern. For example, in the examples of FIGS. 1A, 1B and 1C, the noise substitution of FIG. 1C is more suitable than the repetition of FIG. 1B, whereas in the examples of FIGS. 2A. 2B and 2C, the repetition of FIG. 2B is more suitable than the noise substitution of FIG. 2C.

However, conventionally, various audio interpolation methods according to the error patterns have been proposed, but there has been no interpolation method according to the sound source patterns (see, J. Herre and E. Eberlein, “Evaluation of Concealment Techniques for Compressed Digital Audio”, 94th AES Convention, 1993, preprint 3460, for example).

### DISCLOSURE OF THE INVENTION

Therefore, an object of the present invention is to provide audio data interpolation device and method, audio data related information producing device and method, and their programs and recording media, capable of judging (estimating) a state of sounds of a frame at which an error or loss has occurred in the audio data and carrying out an interpolation according to that state.

Also, another object of the present invention is to provide audio data interpolation information transmission device and method and their programs and recording media, capable of eliminating cases of losing both of some audio frame and the interpolation information regarding that frame.

The present invention provides an audio data interpolation device for interpolating audio data formed by a plurality of frames, the audio data interpolation device characterized by having an input means for inputting said audio data, a detection means for detecting an error or loss of each frame of said audio data, an estimation means for estimating an interpolation information of a frame at which said error or loss is detected, and an interpolation means for interpolating the frame at which said error or loss is detected, by using said interpolation information estimated for that frame by said estimation means.

Also, the present invention is characterized in that each one of said frames has a parameter, and said estimation means judges the parameter of the frame at which said error or loss is detected according to parameters of frames in front of and/or behind of that frame, and estimates a state of the sounds of the frame at which said error or loss is detected according to the parameter of that frame.

Also, the present invention is characterized in that a state transition of said parameter is predetermined, and said estimation means judges the parameter of the frame at which said error or loss is detected according to the parameters of frames in front of and/or behind of that frame and said state transition.

Also, the present invention is characterized in that said estimation means estimates a state of sounds of the frame at which said error or loss is detected, according to an energy of the frame at which said error or loss is detected and similarities with energies of frames in front of or behind of that frame.

Also, the present invention is characterized in that said estimation means obtains said similarities by comparing an energy of each divided region at a time of dividing the frame at which said error or loss is detected in a time region and an energy of each divided region at a time of dividing the frames in front of and/or behind of that frame in a time region.

Also, the present invention is characterized in that said estimation means obtains said similarities by comparing an energy of each divided region at a time of dividing the frame at which said error or loss is detected in a frequency region and an energy of each divided region at a time of dividing the frames in front of and/or behind of that frame in a frequency region.

Also, the present invention is characterized in that said estimation means estimates a state of sounds of the frame at which said error or loss is detected, according to a predictability based on the frames in front of and/or behind of that frame for the frame at which said error or loss is detected.

Also, the present invention is characterized in that said estimation means obtains said predictability according to a bias of a distribution of said audio data in a frequency region.

Also, the present invention is characterized in that said estimation means estimates a state of sounds of the frame at which said error or loss is detected, according to a state of sounds of a frame in front of that frame.

Moreover, the present invention provides an audio data interpolation device for interpolating audio data formed by a plurality of frames, the audio data interpolation device characterized by having an audio data input means for inputting said audio data, an interpolation information input means for inputting an interpolation information of a frame, for each frame of said audio data, a detection means for detecting an error or loss of each frame of said audio data, and an interpolation means for interpolating a frame at which said error or loss is detected, by using said interpolation information inputted for that frame by said interpolation information input means.

Moreover, the present invention provides an audio data interpolation device for interpolating audio data formed by a plurality of frames, the audio data interpolation device characterized by having an audio data input means for inputting said audio data, a detection means for detecting an error or loss of each frame of said audio data, an interpolation information input/estimation means for inputting or estimating an interpolation information of a frame at which said error or loss is detected, and an interpolation means for interpolating the frame at which said error or loss is detected, by using said interpolation information inputted or estimated for that frame by said interpolation information input/estimation means.

Moreover, the present invention provides an audio data related information producing device for producing information related to audio data formed by a plurality of frames, the audio data related information producing device characterized by having an input means for inputting said audio data, and a producing means for producing an interpolation information of a frame, for each frame of said audio data.

Also, the present invention is characterized in that said producing means produces said interpolation information for each frame of said audio data, that contains an energy of that frame and similarities with energies of frames in front of or behind of that frame.

Also, the present invention is characterized in that said producing means produces said interpolation information for each frame of said audio data, that contains a predictability for that frame based on frames in front of or behind of that frame.

Also, the present invention is characterized in that said producing means produces said interpolation information for each frame of said audio data, that contains a state of sounds of that frame.

Also, the present invention is characterized in that said producing means produces said interpolation information for each frame of said audio data, that contains an interpolation method of that frame.

Also, the present invention is characterized in that said producing means causes an error for each frame of said audio data, applies a plurality of interpolation methods to data at which error is caused, and selects the interpolation method to be included in said interpolation information from these plurality of interpolation methods according to application results of these plurality of interpolation methods.

Moreover, the present invention provides an audio data interpolation method for interpolating audio data formed by a plurality of frames, the audio data interpolation method characterized by having a step for inputting said audio data, a step for detecting an error or loss of each frame of said audio data, a step for estimating an interpolation information of a frame at which said error or loss is detected, and a step for interpolating the frame at which said error or loss is detected, by using said interpolation information estimated for that frame by said estimating step.

Also, the present invention provides a program for causing a computer to execute the audio data interpolation method as described above.

Also, the present invention provides a computer readable recording medium that records a program for causing a computer to execute the audio data interpolation method as described above.

Moreover, the present invention provides an audio data interpolation method for interpolating audio data formed by a plurality of frames, the audio data interpolation method characterized by having a step for inputting said audio data, a step for inputting an interpolation information of a frame, for each frame of said audio data, a step for detecting an error or loss of each frame of said audio data, and a step for interpolating a frame at which said error or loss is detected, by using said interpolation information inputted for that frame by said step for inputting the interpolation information.

Also, the present invention provides a program for causing a computer to execute the audio data interpolation method as described above.

Also, the present invention provides a computer readable recording medium that records a program for causing a computer to execute the audio data interpolation method as described above.

Moreover, the present invention provides an audio data interpolation method for interpolating audio data formed by a plurality of frames, the audio data interpolation method characterized by having a step for inputting said audio data, a step for detecting an error or loss of each frame of said audio data, a step for inputting or estimating an interpolation information of a frame at which said error or loss is detected, and a step for interpolating the frame at which said error or loss is detected, by using said interpolation information inputted or estimated for that frame by said step for inputting or estimating the interpolation information.

Also, the present invention provides a program for causing a computer to execute the audio data interpolation method as described above.

Also, the present invention provides a computer readable recording medium that records a program for causing a computer to execute the audio data interpolation method as described above.

Moreover, the present invention provides an audio data related information producing method for producing information related to audio data formed by a plurality of frames, the audio data related information producing method characterized by having a step for inputting said audio data, and a step for producing an interpolation information of a frame, for each frame of said audio data.

Also, the present invention provides a program for causing a computer to execute the audio data interpolation method as described above.

Also, the present invention provides a computer readable recording medium that records a program for causing a computer to execute the audio data interpolation method as described above.

Moreover, the present invention provides an audio data interpolation information transmission device for transmitting an interpolation information of audio data formed by a plurality of frames, the audio data interpolation information transmission device characterized by having an input means for inputting said audio data, a time difference attaching means for giving a time difference between the interpolation information for each frame of said audio data and the audio data of that frame, and a transmission means for transmitting both of said interpolation information and said audio data.

Also, the present invention is characterized in that said transmission means transmits both of said interpolation information and said audio data only in a case where said interpolation information differs from the interpolation information of an immediately previous frame.

Also, the present invention is characterized in that said transmission means transmits said interpolation information by embedding it into the audio data.

Also, the present invention is characterized in that said transmission means transmits only said interpolation information for a plurality of times.

Also, the present invention is characterized in that said transmission means transmits by applying a strong error correction only to said interpolation information.

Also, the present invention is characterized in that said transmission means re-transmits only said interpolation information in response to a re-transmission request.

Moreover, the present invention provides an audio data interpolation information transmission device for transmitting an interpolation information of audio data formed by a plurality of frames, the audio data interpolation information transmission device characterized by having an input means for inputting said audio data, and a transmission means for transmitting the interpolation information for each frame of said audio data separately from said audio data.

Also, the present invention is characterized in that said transmission means transmits both of said interpolation information and said audio data only in a case where said interpolation information differs from the interpolation information of an immediately previous frame.

Also, the present invention is characterized in that said transmission means transmits only said interpolation information for a plurality of times.

Also, the present invention is characterized in that said transmission means transmits by applying a strong error correction only to said interpolation information.

Also, the present invention is characterized in that said transmission means re-transmits only said interpolation information in response to a re-transmission request.

Also, the present invention is characterized in that said transmission device transmits said interpolation information by a reliable another channel which is different from a channel for transmitting said audio data.

Moreover, the present invention provides an audio data interpolation information transmission method for transmitting an interpolation information of audio data formed by a plurality of frames, the audio data interpolation information transmission method characterized by having a step for inputting said audio data, a step for giving a time difference between the interpolation information for each frame of said audio data and the audio data of that frame, and a step for transmitting both of said interpolation information and said audio data.

Also, the present invention provides a program for causing a computer to execute the audio data interpolation method as described above.

Also, the present invention provides a computer readable recording medium that records a program for causing a computer to execute the audio data interpolation method as described above.

Moreover, the present invention provides an audio data interpolation information transmission method for transmitting an interpolation information of audio data formed by a plurality of frames, the audio data interpolation information transmission method characterized by having a step for inputting said audio data, and a step for transmitting the interpolation information for each frame of said audio data separately from said audio data.

Also, the present invention provides a program for causing a computer to execute the audio data interpolation method as described above.

Also, the present invention provides a computer readable recording medium that records a program for causing a computer to execute the audio data interpolation method as described above.

### BRIEF DESCRIPTION OF THE DRAWINGS

FIG. 1 is a figure showing examples of the conventional audio data interpolation.

FIG. 2 is a figure showing other examples of the conventional audio data interpolation.

FIG. 3 is a block diagram showing an exemplary configuration of an interpolation device in the first, second and third embodiments of the present invention.

FIG. 4 is a figure showing an example of a state transition of a parameter determined in advance in the first embodiment of the present invention.

FIG. 5 is a figure for explaining a comparison of energies in the second embodiment of the present invention.

FIG. 6 is another figure for explaining a comparison of energies in the second embodiment of the present invention.

FIG. 7 is a figure for explaining an example of a way for obtaining the predictability in the second embodiment of the present invention.

FIG. 8 is a figure for explaining an example of a method for judging a state of sounds in the second embodiment of the present invention.

FIG. 9 is a block diagram showing an exemplary configuration of an encoding/interpolation information producing device in the second embodiment of the present invention.

FIG. 10 is a block diagram showing another exemplary configuration of an interpolation device in the second embodiment of the present invention.

FIG. 11 is a bloc diagram showing another exemplary configuration of an encoding/interpolation information producing device in the second embodiment of the present invention.

FIG. 12 is a figure showing a packet transmission pattern in the fourth embodiment.

FIG. 13 is a block diagram showing an exemplary configuration of a transmission device in the fourth embodiment.

FIG. 14 is a figure showing a packet transmission pattern in the fifth embodiment.

FIG. 15 is a figure showing a packet transmission pattern in the sixth embodiment.

FIG. 16 is a figure showing a packet transmission pattern in the seventh embodiment.

### BEST MODE FOR CARRYING OUT THE INVENTION

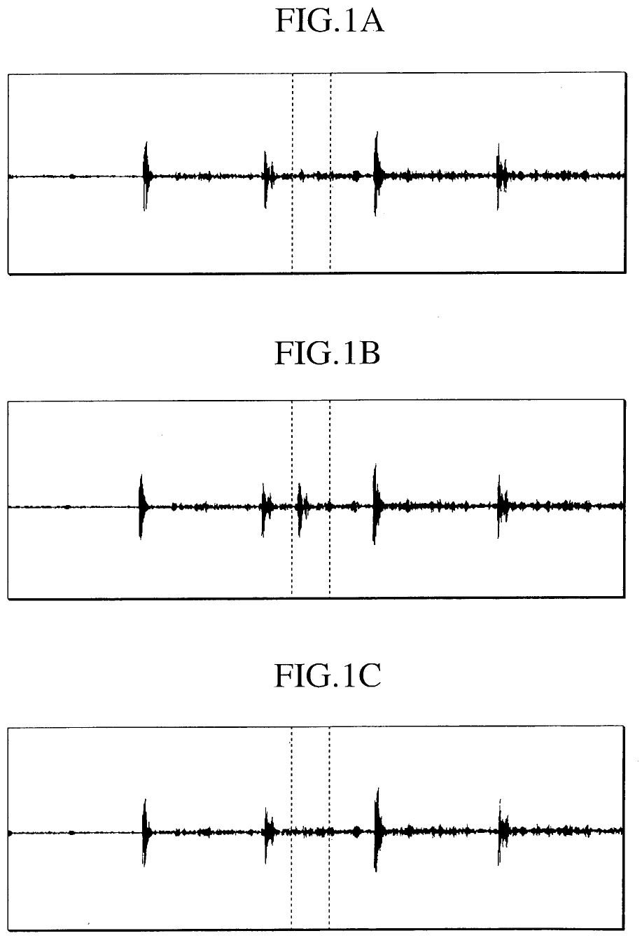

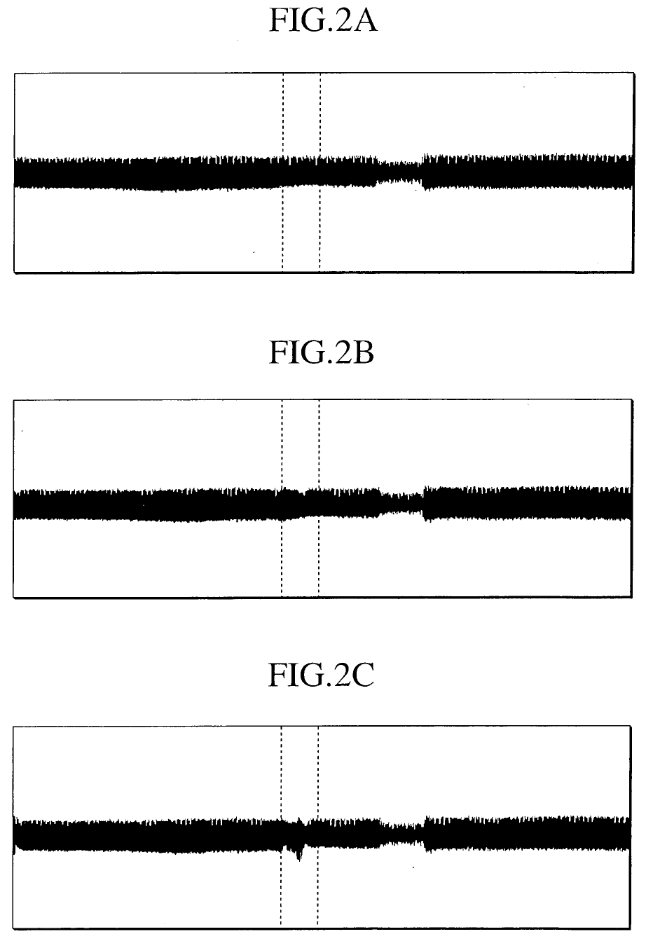

First, embodiments of the audio data interpolation device and method and the audio data related information producing device and method according to the present invention will be described in detail with references to FIG. 1 to FIG. 11.

(First Embodiment)

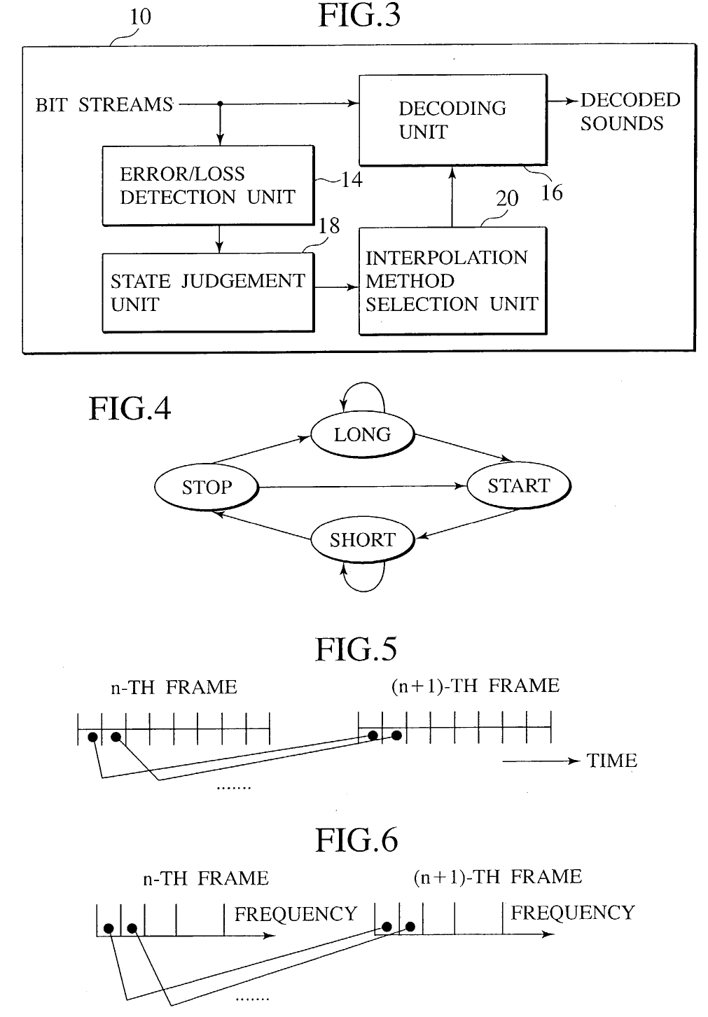

FIG. 3 shows an exemplary configuration of an interpolation device in the first embodiment of the present invention. The interpolation device 10 may be configured as a part of a receiving device for receiving the audio data, or may be configured as an independent device. The interpolation device 10 has an error/loss detection unit 14, a decoding unit 16, a state judgement unit 18 and an interpolation method selection unit 20.

The interpolation device 10 carries out the decoding at the decoding unit 16 for the inputted audio data (bit streams in this embodiment) formed by a plurality of frames, and generates decoded sounds. However, there can be cases where the audio data have an error or loss, so that the audio data are also inputted into the error/loss detection unit 14 and the error or loss of each frame is detected. For a frame at which the error or loss is detected, a state of sounds of that frame (transient or steady in this embodiment) is judged at the state judgement unit 18. At the interpolation method selection unit 20, the interpolation method of that frame is selected according to the judged state of sounds. Then, at the decoding unit 16, the interpolation of that frame (a frame at which the error or loss is detected) is carried out by the selected interpolation method.

In this embodiment, a parameter of the frame at which the error or loss is detected is judged according to parameters of frames in front of and/or behind of that frame and a predetermined state transition of the parameter. Then, the state of sounds of the frame at which the error or loss is detected is judged according to the parameter of that frame. However, at a time of judging the parameter of the frame at which the error or loss is detected, it is also possible to judge it according to only the parameters of the frames in front of and/or behind of that frame, by not taking the state transition of the parameter into consideration.

In this embodiment, at a time of encoding the audio data by the AAC (Advanced Audio Coding) at a transmitting side, a short window is used for transient frames, and a long window is used for the other frames. In order to connect the long window and the short window, a start window and a stop window are there. At the transmitting side, each frame is transmitted by attaching any of short, long, start and stop as a window_sequence information (parameter).

At a receiving (interpolating) side, the window_sequence information of a frame at which the error or loss is detected can be judged according to the window_sequence information of frames in front of and/or behind of that frame and a predetermined state transition of the window_sequence information.

FIG. 4 is a figure showing an example of the predetermined state transition of the parameter (window_sequence information). According to the state transition of FIG. 4, if the window_sequence information of a frame in front of it by one is stop and the window_sequence information of a frame behind of it by one is start, it can be seen that the window_sequence information of the own frame (a frame at which the error or loss is detected) is long. Also, if the window_sequence information of a frame in front of it by one is start, it can be seen that the window_sequence information of the own frame is short. Also, if the window_sequence information of a frame behind of it by one is stop, it can be seen that the window_sequence information of the own frame is short.

According to the window_sequence information of the frame at which the error or loss is detected that is judged in this way, the state of sounds of that frame is judged. For example, when the judged window_sequence information is short, that frame can be judged as transient.

As a method for selecting the interpolation method according to the state of sounds, it is possible to consider a provision of using the noise substitution in the cases of transient and using the repetition or the prediction in the other cases, for example.

(Second Embodiment)

Next, the second embodiment of the present invention will be described. Even in the second embodiment, it is possible to use the interpolation device similar to the interpolation device of the first embodiment shown in FIG. 1.

In this embodiment, the state of sounds of the frame at which the error or loss is detected is judged according to a similarity between an energy of the frame at which the error or loss is detected and an energy of a frame in front of that frame. In addition, the state of sounds of the frame at which the error or loss is detected is judged also according to a predictability for the frame at which the error or loss is detected based on a frame in front of that frame. Note that, in this embodiment, the state of sounds is judged according to the similarity and the predictability, but it is also possible to judge the state of sounds according to one of them.

First, the similarity will be described concretely. In this embodiment, the similarity is obtained by comparing the energy of each divided region at a time of dividing the frame at which the error or loss is detected in a time region and the energy of each divided region at a time of dividing the frame in front of that frame in a time region.

FIG. 5 is a figure for explaining an exemplary energy comparison. In this embodiment, the frame is divided into short time slots, and the energies are compared with the same slot of the next frame. Then, in the case where (a sum of) the energy difference of each slot is less than or equal to a threshold, it is judged that “they are similar”, for example. As for the similarity, it can be indicated as whether they are similar or not (flag), or it can be indicated by the similarity (level) according to the energy difference. Also, the slots to be compared can be all the slot or a part of the slots in the frame.

In this embodiment, the energy comparison is carried out by dividing the frame in a time region, but it is also possible to carry out the energy comparison by dividing the frame in a frequency region instead.

FIG. 6 is another figure for explaining an exemplary energy comparison. In FIG. 6, the frame is divided into sub-bands in a frequency region, and the energies are compared with the same sub-band of the next frame. In the case where (a sum of) the energy difference of each sub-band is less than or equal to a threshold, it is judged that “they are similar”, for example.

In the above description, the similarity is obtained by comparing the energy of the frame of interest with the energy of the frame in front of it by one, but it is also possible to obtain the similarity by the comparison with energies of the two or more frames in front of it, it is also possible to obtain the similarity by the comparison with an energy of the frame behind of it, and it is also possible to obtain the similarity by the comparison with energies of the frames in front of and behind of it.

Next, the predictability will be described concretely. In this embodiment, the predictability is obtained according to a bias of a distribution of the audio data in a frequency region.

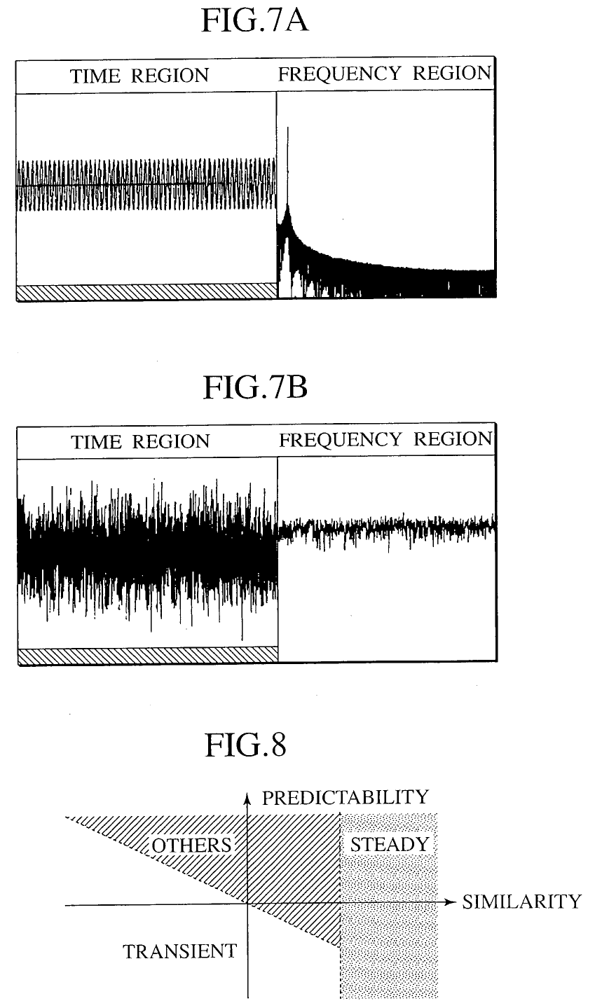

FIGS. 7A and 7B are figures for explaining an exemplary way of obtaining the predictability. In FIGS. 7A and 7B, waveforms of the audio data are shown in a time region and a frequency region. As shown in FIG. 7A, the fact that it is possible to make the prediction can be considered as implying that the correlation in the time region is strong and the spectrum is biased in the frequency region. On the other hand, as shown in FIG. 7B, the fact that it is impossible to make the prediction can be considered as implying that the correlation is weak (or absent) in the time region and the spectrum is flat in the frequency region. As a value of the predictability, it is possible to use GP=arithmetical mean/geometrical mean, for example. In the case where the spectra are biased as 25 and 1 (the case as in FIG. 7A), for example, GP becomes large as indicated in the following.

$${G}_{P} = \frac{( 25 + 1 ) / 2}{{( 25 \times 1 )}^{1 / 2}} = \frac{13}{5}$$

On the other hand, in the case where the spectra are flat as 5 and 5 (the case as in FIG. 7B), for example, GP becomes small as indicated in the following.

$${G}_{P} = \frac{( 5 + 5 ) / 2}{{( 5 \times 5 )}^{1 / 2}} = \frac{5}{5}$$

Note that the predictability can be indicated as whether it is possible to make the prediction or not (flag).

According to the similarity and the predictability obtained as in the above, the state of sounds of the frame at which the error or loss is detected is judged.

FIG. 8 is a figure for explaining an exemplary method for judging the state of sounds. In the example of FIG. 8, it is judged as steady in the case where the similarity is larger than a certain value. On the other hand, it is judged as transient or others in the case where the similarity is smaller than a certain value.

As a method for selecting the interpolation method according to the state of sounds, it is possible to consider a provision of using the noise substitution in the cases of transient, using the repetition in the cases of steady, and using the prediction in the other cases, for example. Note that it is also possible to consider a provision of changing the “others” region (of FIG. 8) where the prediction with a large amount of calculations is going to be carried out in general, according to a performance (calculation performance) of a decoder of the interpolation device, for example.

There are cases where the similarity or the predictability can be calculated at the receiving side (the interpolation device side) and cases where it cannot be calculated at the receiving side. For example, in the case of the scalable coding, if the core layer is received correctly, it is possible to obtain the similarity between that core layer and the core layer of a previous frame. By taking the cases where it cannot be calculated at the receiving side into consideration, it is possible to consider a provision of obtaining the similarity or the predictability at the transmitting side and transmitting it along with the audio data. At the receiving side, it suffices to receive the similarity or the predictability along with the audio data.

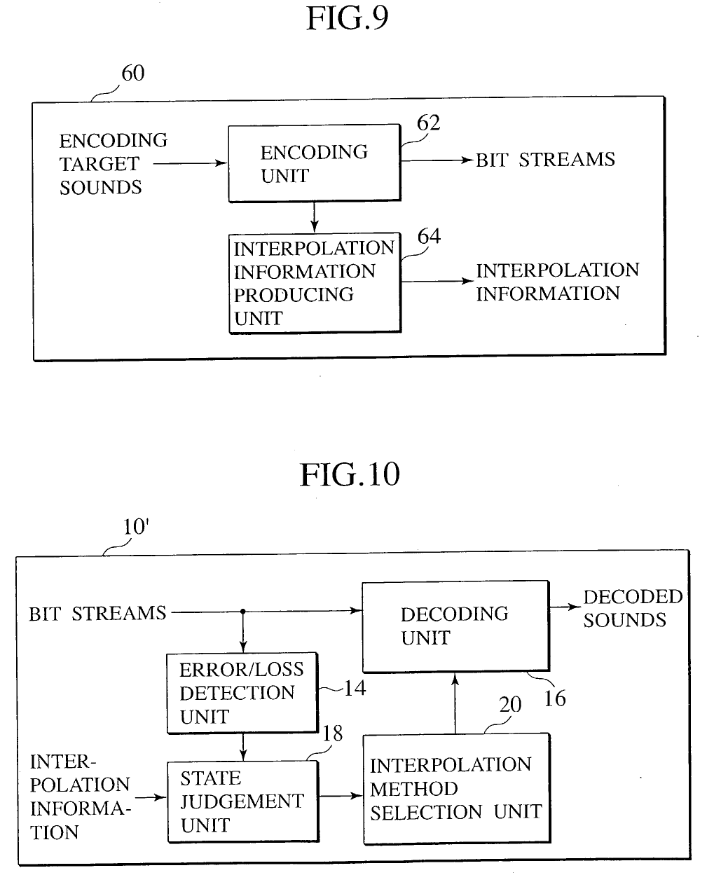

FIG. 9 shows an exemplary configuration of an encoding/interpolation information producing device in this embodiment. The encoding/interpolation information producing device 60 may be configured as a part of a transmission device for transmitting the audio data, or may be configured as an independent device. The encoding/interpolation information producing device 60 has an encoding unit 62 and an interpolation information producing unit 64.

The encoding of the encoding target sounds is carried out at the encoding unit 62 to generate the audio data (bit streams). Also, at the interpolation information producing unit 64, the similarity or the predictability is obtained as the interpolation information (related information) of each frame of the audio data.

The interpolation information can be obtained from the original sounds (encoding target sounds) or a value/parameter in a middle of the encoding. It suffices to transmit the interpolation information obtained in this way along with the audio data (it is also possible to consider a provision of transmitting the interpolation information alone earlier, separately from the audio data). Here, it is possible to realize a further improvement of the quality without increasing the amount of transmission information very much by (1) transmitting the interpolation information with a time difference, (2) transmitting the interpolation information by applying a strong error correction (encoding), or (3) transmitting the interpolation information for a plurality of times, for example.

FIG. 10 shows another exemplary configuration of an interpolation device in this embodiment. The interpolation device 10′ may be configured as a part of a receiving device for receiving the audio data, or may be configured as an independent device. The interpolation device 10′ has an error/loss detection unit 14, a decoding unit 16, a state Judgement unit 18, and an interpolation method selection unit 20.

The interpolation device 10′ also receives the input of the interpolation information besides the audio data (bit streams). The inputted interpolation information (the similarity or the predictability) is used by the state judgement unit 18. Namely, the state of sounds of the frame at which the error or loss is detected is judged according to the interpolation information.

The state judgement unit 18 may be made to judge the state of sounds by solely relying on the inputted interpolation information, or may be made to judge the state of sounds according to the interpolation information in the case where the interpolation information is present and judge the state of sounds by obtaining the similarity or the predictability at the own device in the case where the interpolation information is absent.

In the examples of FIG. 9 and FIG. 10 described above, the similarity or the predictability of each frame is obtained at the transmitting side (the encoding/interpolation information producing device 60 side) and transmitted, but it is also possible to judge the state of sounds of each frame according to the similarity or the predictability at the transmitting side and transmit that judged state of sounds as the interpolation information. It suffices for the interpolation device 10′ to input the received interpolation information into the interpolation method selection unit 20. The interpolation device 10′ may solely rely on the interpolation, or may use the interpolation information only in the case where the interpolation information is present. In the case of solely relying on the interpolation information, the state judgement unit 18 may be absent, and it suffices to input the error/loss detection result into the interpolation method selection unit 20.

It is also possible to judge the state of sounds according to the similarity or the predictability, determines the interpolation method of each frame, and transmit that determined interpolation method as the interpolation information at the transmitting side. It suffices for the interpolation device 10′ to input the received interpolation information into the decoding unit 16. The interpolation device 10′ may solely rely on the interpolation information, or may use the interpolation information only in the case where the interpolation information is present. In the case of solely relying on the interpolation information, the state judgement unit 18 and the interpolation method selection unit 20 may be absent, and it suffices to input the error/loss detection result into the decoding unit 16.

It is also possible to cause an error at the transmitting side, try a plurality of interpolation methods, and select the interpolation method according to that result.

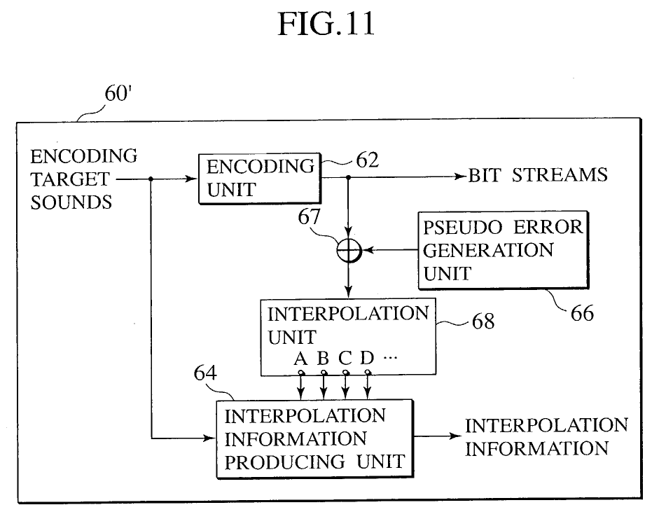

FIG. 11 shows another exemplary configuration of an encoding/interpolation information producing device in this embodiment. The encoding/interpolation information producing device 60′ may be configured as a part of a transmission device for transmitting the audio data, or may be configured as an independent device. The encoding/interpolation information producing device 60′ has an encoding unit 62, an interpolation information producing unit 64, a pseudo error generation unit 66 and an interpolation unit 68.

With respect to the data of each frame of the audio data (bit streams), a pseudo error generated by the pseudo error generation unit 66 is added by an addition unit 67. With respect to the data of each frame at which the error is caused in this way, a plurality of interpolation methods (interpolation methods A, B, C, D, . . . ) are applied by the interpolation unit 68. The application result of each interpolation method is sent to the interpolation information producing unit 64. At the interpolation information producing unit 64, the application result (data) of each interpolation method is decoded, and compared with the original encoding target sounds. Then, the optimal interpolation method is selected according to that comparison result, and transmitted as the interpolation information of that frame.

Note that, at the interpolation information producing unit 64, instead of decoding the application result of each interpolation method and comparing it with the encoding target sounds, it is also possible to select the interpolation method by comparing the application result of each interpolation method with the audio data (bit streams) before the error is caused.

Note that, even in the first embodiment, similarly as described above, it is possible to judge the state of sounds of each frame according to the parameter of that frame and transmit that judged state of sounds as the interpolation information at the transmitting side. It is also possible to judge the state of sounds of each frame according to the parameter of that frame, determine the interpolation method of each frame according to that judged state of sounds, and transmit that determined interpolation method as the interpolation information at the transmitting side. It is also possible to cause an error at the transmitting side, try a plurality of interpolation methods, and select the interpolation method according to that result.

(Third Embodiment)

Next, the third embodiment of the present invention will be described. Even in the third embodiment, it is possible to use the interpolation device similar to the interpolation device of the first embodiment shown in FIG. 1.

In this embodiment, the state of sounds of a frame at which the error or loss is detected is judged according to the state of sounds of a frame in front of that frame. However, it is also possible to make the judgement by taking the state of sounds of a frame behind of it into the consideration as well.

It is possible to consider a provision of maintaining a log of the state of sounds of the frame, and judging that a next frame is also steady if the steady state is continuing for a long period, for example. It is similar for the transient.

It is also possible to consider a provision of maintaining a log of transitions of the state of sounds of the frame, and judging the state of sounds of the frame at which the error or loss is detected according to that log, for example. For example, it is possible to consider a provision of judging according to an n-th degree conditional probability of a transition of the state of sounds (a probability for becoming transient next or a probability for becoming steady, etc., when three transient states are consecutive, for example). The n-th degree conditional probability is updated occasionally.

Note that, even in this embodiment, similarly as in the second embodiment, it is possible to judge the state of sounds of each frame according to the state of sounds of a frame in front of that frame and transmit that judged state of sounds as the interpolation information at the transmitting side. It is also possible to judge the state of sounds of each frame according to the state of sounds of a frame in front of that frame, determine the interpolation method of each frame according to that judged state of sounds, and transmit that determined interpolation method as the interpolation information at the transmitting side.

Note that it is also possible to make the judgement of the state of sounds by combining the judgement methods of the first to third embodiments described above. In the case of combining them, it suffices to give weights to the judgement methods and make the judgement comprehensively.

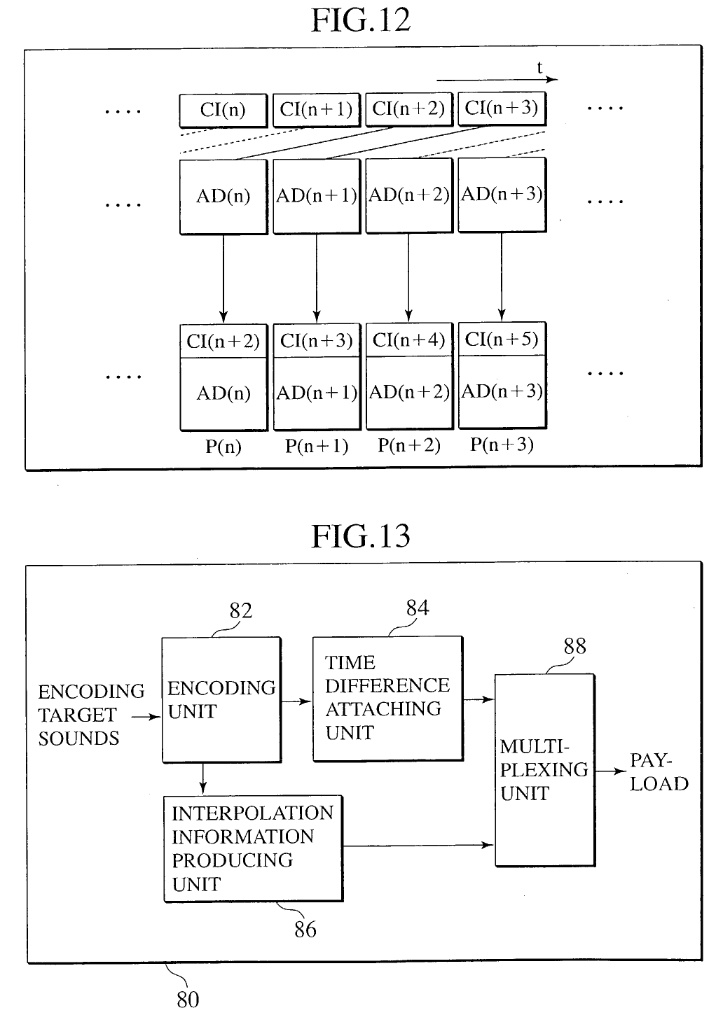

Next, embodiments of the audio data interpolation information transmission device and method according to the present invention will be described in detail with references to FIG. 12 to FIG. 16.

The audio data interpolation devices of the first to third embodiments described above are ones that switch the interpolation method by using the error interpolation information as a technique for compensating errors of the audio data, which can carry out the optimal interpolation with respect to the loss of the audio data by producing the interpolation information on a basis of the sound source without errors before the transmission, and which have an excellent effect in that the redundancy due to the interpolation information is small, but they do not mention the transmission method of the interpolation information, and a way of transmission such that the interpolation information regarding the lost audio data is also lost together will have a problem in that the interpolation method cannot be switched appropriately.

For this reason, in the following fourth to seventh embodiments, it is made such that the possibility for either one of the interpolation information and the audio data exists becomes high, and the appropriate interpolation method can be applied in the case where the audio data is lost. Also, by embedding the interpolation information into the audio data, it is made possible to decode the audio data even by a decoder that is not compatible with the interpolation information. In addition, it is made possible to suppress the redundancy by transmitting only in the case where the interpolation method is different from the previous frame. Note that, it is commonly assumed in the following embodiments that, with respect to each frame AD(n), AD(n+1), AD(n+2), . . . of the audio data, there exists the interpolation information CI(n), CI(n+1), CI(n+2), . . . for indicating the optimal interpolation methods in the case where that frame is lost.

(Fourth Embodiment)

FIG. 12 shows a packet transmission pattern in the case of transmission by giving a time difference of two frames to the audio frame and the interpolation information. The packet P(n) contains the frame AD(n) and the interpolation information CI(n+2), the packet P(n+2) contains the frame AD(n+2) and the interpolation information CI(n+4). In the case where the packet P(n+2) is lost, if the packet P(n) is already received, the degradation of the decoded sound quality can be suppressed by carrying out the optimal interpolation by using the interpolation information CI(n+2) for the lost frame AD(n+2) portion.

The time difference x may be fixed, or may be variable for each audio data or each frame. For example, it is possible to provide the tolerance with respect to the bursty error by making it random for each frame, or it is possible to change it adaptively according to the error state of the transmission path. It is also possible to transmit a plurality of interpolation informations CI together with respect to one frame AD. In FIG. 12, the case of transmitting one interpolation information CI for one frame AD with the fixed x=2 is shown.

FIG. 13 shows an exemplary configuration of a transmission device in this embodiment. The transmission device 80 has an encoding unit 82, a time difference attaching unit 84, an interpolation information producing unit 86, and a multiplexing unit 88.

In the case where the time difference information “x” is already known at both sides of the transmitting side and the receiving side, as in the case where it is negotiated in advance by the transmitting side and the receiving side or it is obtained by the calculation from a specific parameter, it may be possible not to transmit the information for indicating that it is the interpolation information of which frame (which will be referred to as an indication information in the following). In the case where there is a need to indicate that it is the interpolation information of which frame, it is possible to consider a provision of transmitting the indication information such as the time difference information “x” or the frame ID “n+x” or the absolute reproduction time of that frame, along with the interpolation information CI(n+x).

It is possible to consider a provision of including the interpolation information CI and the indication information as padding bits of the IP packet, for example. Also, in the case where the audio data are encoded by AAC of MPEG-2 or MPEG-4 (as disclosed in the MPEG standard specification document ISO/IEC 13818-7 or ISO/IEC 14496-3), they can be included within the data_stream_element, and by embedding them into the MDCT (Modified Discrete Cosine Transform) coefficient immediately before the Huffman coding by using the data embedding technique (as disclosed in Proceedings of the IEEE, Vol. 87, No. 7, July 1999, pp. 1062-1078, “Information Hiding—A Survey”), it becomes possible even for the receiving side to completely take out the interpolation information CI and the indication information because the Huffman coding is the reversible compression.

As a method for embedding into the MDCT coefficient, it is possible to consider a method for operating the coefficient such that the lowermost bit of the specific MDCT coefficient coincides with the interpolation information, for example. The coefficient for embedding is preferably be a position where the degradation of the quality that can occur as a result of operating the coefficient is as small as possible, and the overhead that can increase as a result of changing the Huffman code by operating the coefficient is as small as possible.

As a method for notifying that the data embedding is made to the receiving side, it is possible to consider the use of a marker bit of a header of RTP (Realtime Transport Protocol) (as disclosed in the IETF standard specification document RFC 1889), for example. Also, in the case of embedding data and transmitting the interpolation information only for a frame at which the interpolation method changes, a flag indicating whether the interpolation information is embedded in that frame or not becomes necessary for each frame, but it is also possible to consider a provision of embedding this flag itself in the audio data.

(Fifth Embodiment)

In the fifth embodiment, in the method for transmitting the interpolation information CI by giving a time difference from the frame AD similarly as in the fourth embodiment, it is made such that the interpolation information CI(n+1) is transmitted only in the case where the interpolation method changes, that is, the case of CI(n)≠CI(n+1).

The transmission device in this embodiment can be made to have the configuration similar to the transmission device of FIG. 13 described above.

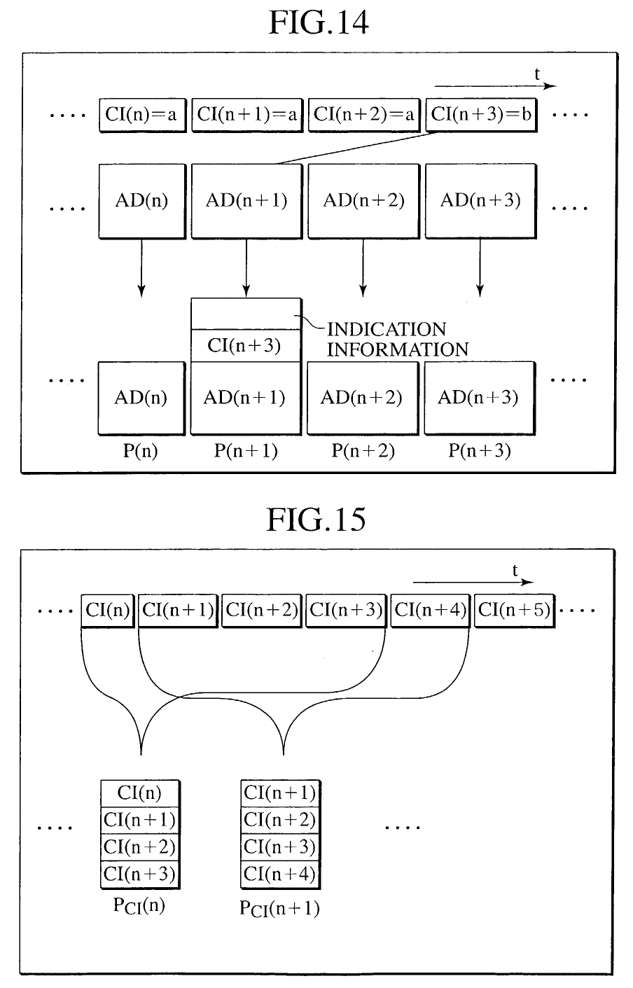

FIG. 14 shows a packet transmission pattern in the case of transmitting the interpolation information only for a frame at which the interpolation method changes and transmitting the indication information together. In the case where the time difference information “x” is already known at both sides of the transmitting side and the receiving side, it may be possible not to transmit the indication information.

At a time of transmitting the interpolation information CI only in the case where it changes, if that interpolation information CI is lost, an incorrect one would be propagated until the interpolation information CI changes next, so that it is preferable to use the loss compensation technique with respect to the interpolation information CI along with the time difference.

For one thing, it is possible to mention a provision of transmitting only the interpolation information for a plurality of times. In FIG. 14, the fifth embodiment CI(n+3) is contained only in the packet P(n+1), but by including it in the packet P(n) and the packet P(n+1), the interpolation information CI(n+3) exists even when the packet P(n+1) is lost and it is possible to switch the interpolation method.

For another thing, there is a provision for applying the strong error correction only to the interpolation information. For example, it is possible to consider a provision of using the FEC (Forward Error Correction) only for the interpolation information CI and including the FEC data in another packet. It is possible to make it such that a packet in which the FEC data are to be included is already known at both sides of the transmitting side and the receiving side, or it is possible to indicate that it is the FEC data by the indication information.

It is also possible to consider a provision of re-transmitting only the interpolation information. For example, a possibility for having the interpolation information CI received can be increased by making the automatic re-transmission request only for the interpolation information CI by using the ARQ (Automatic Repeat Request), and the redundancy due to the re-transmission can be suppressed by not using the ARQ for the audio data.

Note that, even in the fourth embodiment, similarly as described above, it is possible to use the loss compensation technique with respect to the interpolation information CI.

(Sixth embodiment)

In the sixth embodiment, the audio data and the interpolation information are transmitted separately. In this case, it suffices to set the payload type of the RTP header to be different ones for the audio data and the interpolation information, for example. The interpolation informations for a plurality of frames may be contained in one packet.

The transmission device in this embodiment can be made to have the configuration similar to the encoding/interpolation information producing device of FIG. 9 or FIG. 11 described above.

FIG. 15 shows a packet transmission pattern in the case of transmitting only the interpolation information for four times. The interpolation informations for a plurality of frames contained in one packet may not necessarily be those of the consecutive frames. The indication information is also transmitted together with the interpolation information CI if necessary.

(Seventh Embodiment)

In the seventh embodiment, in the method for transmitting the frame AD and the interpolation information CI similarly as in the sixth embodiment, the interpolation information CI is transmitted only in the case where the interpolation method changes similarly as in the fifth embodiment. In that case, the indication information is also transmitted along with the interpolation information CI.

The transmission device in this embodiment can be made to have the configuration similar to the encoding/interpolation information producing device of FIG. 9 or FIG. 11 described above.

At a time of transmitting the interpolation information CI only in the case where it changes, if that interpolation information CI is lost, an incorrect one would be propagated until the interpolation information CI changes next, so that it is preferable to use the loss compensation technique with respect to the interpolation information CI. In the case of applying the strong error correction only to the interpolation information, similarly as in the fifth embodiment, it is possible to consider a provision of using the FEC, for example.

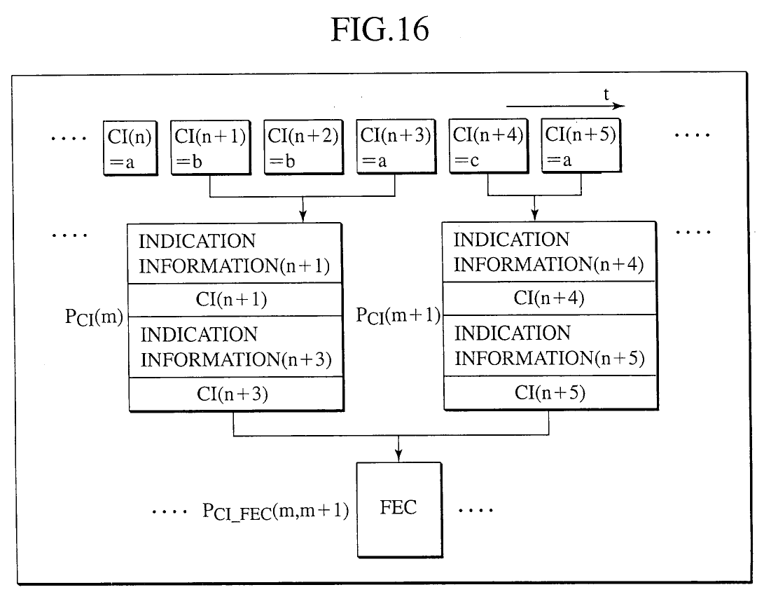

FIG. 16 shows a packet transmission pattern in the case of applying the FEC only to the interpolation information and transmitting the interpolation information only for a frame at which the interpolation method changes. It is possible to include the interpolation informations for a plurality of frames in one packet, and separately generate the FEC packet (PCI_{—}FEC) (as disclosed in the IETF standard specification document RFC 2733), or it is also possible to transmit the interpolation information CI(n) and the FEC information regarding the interpolation information CI(n+1) by including them in another CI packet (PCI) in which the interpolation information CI(n) and the interpolation information CI(n+1) are not included. It is possible to use different FEC rates in such a manner that it is 1PCI-FEC per 2PCI for the interpolation information CI and it is 1PCI-FEC per 5PAD for the frame AD, for example, or it is also possible not to apply the FEC at all to the frame AD.

Even in the case of re-transmitting only the interpolation information, similarly as in the fifth embodiment, it is possible to consider a provision of using the ARQ only for the packet of the interpolation information, for example. In the line switching, it is possible to consider a provision of collecting only the interpolation informations earlier and transmitting them by using the ARQ in advance. Also, in the case of transmitting only the interpolation information by another reliable channel, it is possible to consider a provision of transmitting the interpolation information by the TCP/IP and transmitting the audio data by the RTP/UDP/IP, for example.

Note that, even in the sixth embodiment, similarly as described above, it is possible to use the loss compensation technique with respect to the interpolation information CI.

Also, the fourth to seventh embodiments described above are explained by using the packet switching network as an example, but the present invention can be realized similarly even in the line switching network by using the frame synchronization.

As described above, according to the present invention, it is possible to judge the state of sounds of the frame at which the error or loss has occurred in-the audio data, and carry out the interpolation according to that state. In this way, it is possible to improve the decoded sound quality.

Also, according to the present invention, the possibility for either one of some audio frame or the interpolation information regarding that frame exists becomes high, it is possible to apply the appropriate interpolation method in the case where the audio data is lost, and it is possible to improve the decoding quality by using only the small redundancy.

Note that the interpolation device, the encoding/interpolation information producing device, or the transmission device of the first to seventh embodiments described above can be a device that carries out the operations such as the interpolation, the encoding, or the interpolation information producing as described above according to a program stored in a memory or the like of the own device. Also, it is possible to consider a provision of writing the program into a recording medium (CD-ROM or magnetic disk, for example) or reading it from the recording medium.

Also, the present invention is not to be limited to the embodiments described above, and it can be practiced in various modifications within a range of not deviating from its essence.

1. An audio data interpolation device for interpolating audio data formed by a plurality of frames, the audio data interpolation device characterized by having
an input means for inputting said audio data,
a detection means for detecting an error or loss of each frame of said audio data,
an estimation means for estimating an interpolation information of a frame at which said error or loss is detected, and
an interpolation means for interpolating the frame at which said error or loss is detected, by using said interpolation information estimated for that frame by said estimation means.

2. The audio data interpolation device as described in claim 1, the audio data interpolation device characterized in that each one of said frames has a parameter, and said estimation means judges the parameter of the frame at which said error or loss is detected according to parameters of frames in front of and/or behind of that frame, and estimates a state of the sounds of the frame at which said error or loss is detected according to the parameter of that frame.

3. The audio data interpolation device as described in claim 2, the audio data interpolation device characterized in that a state transition of said parameter is predetermined, and said estimation means judges the parameter of the frame at which said error or loss is detected according to the parameters of frames in front of and/or behind of that frame and said state transition.

4. The audio data interpolation device as described in claim 1, the audio data interpolation device characterized in that said estimation means estimates a state of sounds of the frame at which said error or loss is detected, according to an energy of the frame at which said error or loss is detected and similarities with energies of frames in front of or behind of that frame.

5. The audio data interpolation device as described in claim 4, the audio data interpolation device characterized in that said estimation means obtains said similarities by comparing an energy of each divided region at a time of dividing the frame at which said error or loss is detected in a time region and an energy of each divided region at a time of dividing the frames in front of and/or behind of that frame in a time region.

6. The audio data interpolation device as described in claim 4, the audio data interpolation device characterized in that said estimation means obtains said similarities by comparing an energy of each divided region at a time of dividing the frame at which said error or loss is detected in a frequency region and an energy of each divided region at a time of dividing the frames in front of and/or behind of that frame in a frequency region.

7. The audio data interpolation device as described in claim 1, the audio data interpolation device characterized in that said estimation means estimates a state of sounds of the frame at which said error or loss is detected, according to a predictability based on the frames in front of and/or behind of that frame for the frame at which said error or loss is detected.

8. The audio data interpolation device as described in claim 7, the audio data interpolation device characterized in that said estimation means obtains said predictability according to a bias of a distribution of said audio data in a frequency region.

9. The audio data interpolation device as described in claim 1, the audio data interpolation device characterized in that said estimation means estimates a state of sounds of the frame at which said error or loss is detected, according to a state of sounds of a frame in front of that frame.

10. An audio data interpolation device for interpolating audio data formed by a plurality of frames, the audio data interpolation device characterized by having
an audio data input means for inputting said audio data,
an interpolation information input means for inputting an interpolation information of a frame, for each frame of said audio data,
a detection means for detecting an error or loss of each frame of said audio data, and
an interpolation means for interpolating a frame at which said error or loss is detected, by using said interpolation information inputted for that frame by said interpolation information input means.

11. An audio data interpolation device for interpolating audio data formed by a plurality of frames, the audio data interpolation device characterized by having
an audio data input means for inputting said audio data,
a detection means for detecting an error or loss of each frame of said audio data,
an interpolation information input/estimation means for inputting or estimating an interpolation information of a frame at which said error or loss is detected, and
an interpolation means for interpolating the frame at which said error or loss is detected, by using said interpolation information inputted or estimated for that frame by said interpolation information input/estimation means.

12. An audio data related information producing device for producing information related to audio data formed by a plurality of frames, the audio data related information producing device characterized by having
an input means for inputting said audio data, and
a producing means for producing an interpolation information of a frame, for each frame of said audio data.

13. The audio data related information producing device as described in claim 12, the audio data related information producing device characterized in that said producing means produces said interpolation information for each frame of said audio data, that contains an energy of that frame and similarities with energies of frames in front of or behind of that frame.

14. The audio data related information producing device as described in claim 12, the audio data related information producing device characterized in that said producing means produces said interpolation information for each frame of said audio data, that contains a predictability for that frame based on frames in front of or behind of that frame.

15. The audio data related information producing device as described in claim 12, the audio data related information producing device characterized in that said producing means produces said interpolation information for each frame of said audio data, that contains a state of sounds of that frame.

16. The audio data related information producing device as described in claim 12, the audio data related information producing device characterized in that said producing means produces said interpolation information for each frame of said audio data, that contains an interpolation method of that frame.

17. The audio data related information producing device as described in claim 16, the audio data related information producing device characterized in that said producing means causes an error for each frame of said audio data, applies a plurality of interpolation methods to data at which error is caused, and selects the interpolation method to be included in said interpolation information from these plurality of interpolation methods according to application results of these plurality of interpolation methods.

18. An audio data interpolation method for interpolating audio data formed by a plurality of frames, the audio data interpolation method characterized by having
a step for inputting said audio data,
a step for detecting an error or loss of each frame of said audio data,
a step for estimating an interpolation information of a frame at which said error or loss is detected, and
a step for interpolating the frame at which said error or loss is detected, by using said interpolation information estimated for that frame by said estimating step.

19. A program for causing a computer to execute the audio data interpolation method as described in claim 18.

20. A computer readable recording medium that records a program for causing a computer to execute the audio data interpolation method as described in claim 18.

21. An audio data interpolation method for interpolating audio data formed by a plurality of frames, the audio data interpolation method characterized by having
a step for inputting said audio data,
a step for inputting an interpolation information of a frame, for each frame of said audio data,
a step for detecting an error or loss of each frame of said audio data, and
a step for interpolating a frame at which said error or loss is detected, by using said interpolation information inputted for that frame by said step for inputting the interpolation information.

22. A program for causing a computer to execute the audio data interpolation method as described in claim 21.

23. A computer readable recording medium that records a program for causing a computer to execute the audio data interpolation method as described in claim 21.

24. An audio data interpolation method for interpolating audio data formed by a plurality of frames, the audio data interpolation method characterized by having
a step for inputting said audio data,
a step for detecting an error or loss of each frame of said audio data,
a step for inputting or estimating an interpolation information of a frame at which said error or loss is detected, and
a step for interpolating the frame at which said error or loss is detected, by using said interpolation information inputted or estimated for that frame by said step for inputting or estimating the interpolation information.

25. A program for causing a computer to execute the audio data interpolation method as described in claim 24.

26. A computer readable recording medium that records a program for causing a computer to execute the audio data interpolation method as described in claim 24.

27. An audio data related information producing method for producing information related to audio data formed by a plurality of frames, the audio data related information producing method characterized by having
a step for inputting said audio data, and
a step for producing an interpolation information of a frame, for each frame of said audio data.

28. A program for causing a computer to execute the audio data interpolation method as described in claim 27.

29. A computer readable recording medium that records a program for causing a computer to execute the audio data interpolation method as described in claim 27.

30. An audio data interpolation information transmission device for transmitting an interpolation information of audio data formed by a plurality of frames, the audio data interpolation information transmission device characterized by having
an input means for inputting said audio data,
a time difference attaching means for giving a time difference between the interpolation information for each frame of said audio data and the audio data of that frame, and
a transmission means for transmitting both of said interpolation information and said audio data.

31. The audio data interpolation information transmission device as described in claim 30, the audio data interpolation information transmission device characterized in that said transmission means transmits both of said interpolation information and said audio data only in a case where said interpolation information differs from the interpolation information of an immediately previous frame.

32. The audio data interpolation information transmission device as described in claim 30, the audio data interpolation information transmission device characterized in that said transmission means transmits said interpolation information by embedding it into the audio data.

33. The audio data interpolation information transmission device as described in claim 30, the audio data interpolation information transmission device characterized in that said transmission means transmits only said interpolation information for a plurality of times.

34. The audio data interpolation information transmission device as described in claim 30, the audio data interpolation information transmission device characterized in that said transmission means transmits by applying a strong error correction only to said interpolation information.

35. The audio data interpolation information transmission device as described in claim 30, the audio data interpolation information transmission device characterized in that said transmission means re-transmits only said interpolation information in response to a re-transmission request.

36. An audio data interpolation information transmission device for transmitting an interpolation information of audio data formed by a plurality of frames, the audio data interpolation information transmission device characterized by having
an input means for inputting said audio data, and
a transmission means for transmitting the interpolation information for each frame of said audio data separately from said audio data.

37. The audio data interpolation information transmission device as described in claim 36, the audio data interpolation information transmission device characterized in that said transmission means transmits both of said interpolation information and said audio data only in a case where said interpolation information differs from the interpolation information of an immediately previous frame.

38. The audio data interpolation information transmission device as described in claim 36, the audio data interpolation information transmission device characterized in that said transmission means transmits only said interpolation information for a plurality of times.

39. The audio data interpolation information transmission device as described in claim 36, the audio data interpolation information transmission device characterized in that said transmission means transmits by applying a strong error correction only to said interpolation information.

40. The audio data interpolation information transmission device as described in claim 30, the audio data interpolation information transmission device characterized in that said transmission means re-transmits only said interpolation information in response to a re-transmission request.

41. The audio data interpolation information transmission device as described in claim 30, the audio data interpolation information transmission device characterized in that said transmission device transmits said interpolation information by a reliable another channel which is different from a channel for transmitting said audio data.

42. An audio data interpolation information transmission method for transmitting an interpolation information of audio data formed by a plurality of frames, the audio data interpolation information transmission method characterized by having
a step for inputting said audio data,
a step for giving a time difference between the interpolation information for each frame of said audio data and the audio data of that frame, and
a step for transmitting both of said interpolation information and said audio data.

43. A program for causing a computer to execute the audio data interpolation method as described in claim 42.

44. A computer readable recording medium that records a program for causing a computer to execute the audio data interpolation method as described in claim 42.

45. An audio data interpolation information transmission method for transmitting an interpolation information of audio data formed by a plurality of frames, the audio data interpolation information transmission method characterized by having
a step for inputting said audio data, and
a step for transmitting the interpolation information for each frame of said audio data separately from said audio data.

46. A program for causing a computer to execute the audio data interpolation method as described in claim 45.

47. A computer readable recording medium that records a program for causing a computer to execute the audio data interpolation method as described in claim 45.
